(19) United States
(12) Patent Application Publication
(10) Pub. No.: US 2009/0015806 A1
(43) Pub. Date: Jan. 15, 2009

(54) Environmental control apparatus, stage apparatus, exposure apparatus and device manufacturing method

(75) Inventor: Yoichi Arai, Honjo-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/155,385

(22) Filed: Jun. 3, 2008

Related U.S. Application Data
(60) Provisional application No. 60/929,104, filed on Jun. 13, 2007.

(30) Foreign Application Priority Data
Jun. 4, 2007 (JP) 2007-148051

(51) Int. Cl. G03B 27/52

(52) U.S. Cl. 355/30

(57) ABSTRACT

An environment control apparatus comprises a first member, which has a first opening, which forms a first space and is formed at least a part and a first surface provided in the vicinity of the first opening, and a movable member, which has a second surface, which is arranged so as to cover the first opening and opposes the first surface, and is capable of relative movement with respect to the first opening while being guided by the first surface, and a gas seal mechanism is formed between the first surface and the second surface, and it is capable of setting the first space to a prescribed status.

### CROSS-REFERENCE TO RELATED APPLICATION

This application is a non-provisional application claiming priority to and the benefit of U.S. provisional application No. 60/929,104, filed Jun. 13, 2007. Furthermore, this application claims priority to Japanese Patent Application No. 2007-148051, filed Jun. 4, 2007. The entire contents of which are incorporated herein by reference.

### BACKGROUND

1. Field of the Invention

The present invention relates to an environment control apparatus that controls the environment of a space, a stage apparatus that moves while holding an object, an exposure apparatus that exposes a substrate using exposure light, and a device manufacturing method.

2. Related Art

Exposure apparatuses used in the photolithography process have a mask stage, which is able to move while holding a mask on which a pattern has been formed, and a substrate stage, which is able to move while holding a photosensitive substrate, and illuminate the mask using exposure light and expose the substrate using the exposure light from that mask. In the exposure apparatus, control is performed by means of, for example, an environment control apparatus called a chamber apparatus, so that the environment of a prescribed space through which the exposure light advances comes to the desired status. An example of technology relating to an environment control apparatus is disclosed in U.S. Patent Application Publication No. 2003/0058426.

For example, there are cases in which a prescribed space is opened in order to access equipment, members, etc. arranged in the prescribed space through which the exposure light advances. For example, when the prescribed space is opened for the purpose of adjustment processing, maintenance processing, etc. of a stage apparatus such as a mask stage, a substrate stage, etc. arranged in the prescribed space through which exposure light advances, there is a possibility that the environment of the prescribed space will change. In cases in which time is required for the process of returning the changed environment of the prescribed space to the desired status, there is a possibility that the operation rate of the exposure apparatus will decrease.

A purpose of some aspects of the present invention is to provide an environment control apparatus that is able to restrict changes in the environment of the prescribed space. Another purpose is to provide a stage apparatus that is able to restrict changes in the environment of the prescribed space. Further another purpose is to provide an exposure apparatus that is able to restrict decreases in the operation rate and expose a substrate well in addition to a device manufacturing method that uses that exposure apparatus.

### SUMMARY

Provided according to a first aspect of the present invention is an environment control apparatus that comprises: a first member that forms a first space and that has a first opening and a first surface, the first opening being formed at least a part of the first member, the first surface being provided in the vicinity of the first opening: and a movable member that has a second surface and that is capable of relative movement with respect to the first opening while being guided by the first surface, the second surface being arranged so as to cover the first opening and opposing the first surface, wherein a gas seal mechanism is formed between the first surface and the second surface, and the first space can be set to a prescribed status.

Provided according to a second aspect of the present invention is a stage apparatus that is able to move while holding an object, comprising: a movable member, which is able to move while holding an object so that the object is arranged in a first space via a first opening formed in at least a part of a first member that forms the first space; and a gas seal mechanism, which has a first surface and a second surface and that forms a gas seal by means of the first surface and the second surface, the first surface being provided in the vicinity of the first opening of the first member and a second surface, relative movement between the first surface and the second surface being allowed.

Provided according to a third aspect of the present invention is an exposure apparatus that exposes a substrate with exposure light, comprising: a first member that forms a first space through which the exposure light advances and that has a first opening and a first surface, the first opening being formed at least a part of the first member at which the exposure light that has advanced through the first space can be incident, the first surface being provided in the vicinity of the first opening; a movable member, which has a second surface, and which is capable of relative movement with respect to the first opening while being guided by the first surface, the second surface being arranged so as to cover the first opening and opposing the first surface; and a gas seal mechanism, which is formed between the first surface and the second surface.

Provided according to a fourth aspect of the present invention is a device manufacturing method that includes exposing a substrate using an exposure apparatus of the above mode and developing the exposed substrate.

According to the some aspects of the present invention, changes in the environment of the prescribed space can be restricted. In addition, according to the some aspects of the present invention, it is possible to restrict decreases in the operation rate of the apparatus, and it is possible to expose the substrate well.

### BRIEF DESCRIPTION OF THE DRAWINGS

FIG. 1 is a schematic block diagram that shows an example of an exposure apparatus relating to the first embodiment.

FIG. 2 is a drawing that describes an example of the operation of the mask stage relating to the first embodiment.

FIG. 3 is a cross-sectional view that shows the vicinity of the mask stage relating to the first embodiment.

FIG. 4 is a drawing that enlarges a part of FIG. 3.

FIG. 5 is an oblique view that shows the vicinity of the mask stage relating to the first embodiment.

FIG. 6 is a schematic view that shows a part of an exposure apparatus relating to the second embodiment.

FIG. 7 is a schematic view that shows a part of an exposure apparatus relating to the second embodiment.

FIG. 8 is a flowchart that shows an example of a microdevice fabrication process.

### DESCRIPTION OF EMBODIMENTS

An embodiment of the present invention will be described below while referring to drawings. The present invention is not limited by this. Note that, in the following description, an XYZ rectangular coordinate system will be set up, and the positional relationships among the respective members will be explained while referring to this XYZ rectangular coordinate system. In addition, a prescribed direction within the horizontal plane is the X axis direction, a direction perpendicular to the X axis direction within the horizontal plane is the Y axis direction, and a direction (that is, the vertical direction) respectively perpendicular to the X axis direction and the Y axis direction is the Z axis direction. In addition, the directions of rotation (tilting) about the X axis, the Y axis and the Z axis are the θX, θY and θZ directions respectively.

### First Embodiment

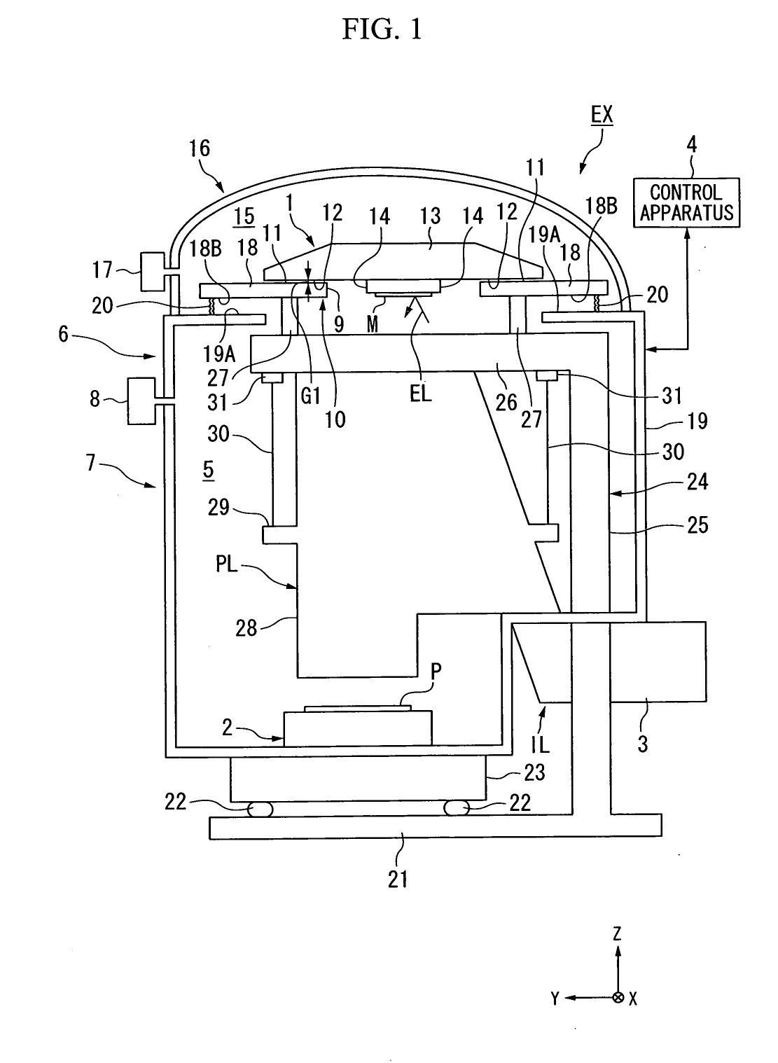

A first embodiment will be explained. FIG. 1 is a schematic block diagram that shows an exposure apparatus EX relating to the first embodiment. In the present embodiment, a description is given using the example of the case in which the exposure apparatus EX is an EUV exposure apparatus that exposes a substrate P using extreme ultraviolet (EUV) light. Extreme ultraviolet light is electromagnetic waves in the soft x-ray range with a wavelength of, for example, approximately 5 to 50 nm. In the following description, extreme ultraviolet light is called EUV light as appropriate. As an example, in the present embodiment, EUV light with a wavelength of 13.5 nm will be used as the exposure light EL.

First, a schematic of the exposure apparatus EX relating to the present embodiment will be described. In FIG. 1, the exposure apparatus EX comprises a mask stage 1 that is able to move while holding a mask M on which a pattern is formed, and a substrate stage 2 that is able to move while holding a substrate P, a light source apparatus 3, which generates exposure light EL, and an illumination optical system IL, which illuminates a mask M using exposure light EL from the light source apparatus 3, a projection optical system PL, which projects the image of the pattern of the mask M illuminated by the exposure light EL to the substrate P, and a control apparatus 4, which controls the operations of the entire exposure apparatus EX. The substrate P includes those in which a film such as a photosensitive material (resist) has been formed on the surface of base material such as a semiconductor wafer. The mask M includes reticles on which the device pattern to be projected onto the substrate P is formed.

In the present embodiment, the mask M is a reflecting type mask that has a multilayer film that is capable of reflecting EUV light. The exposure apparatus EX uses exposure light EL (EUV light) to illuminate the surface (reflecting surface) of the mask M, on which a pattern has been formed by multilayer film, and the substrate P, which has photosensitivity is exposed using exposure light EL reflected by the mask M.

The exposure apparatus EX of the present embodiment comprises a chamber apparatus 6 that is able to set the first space 5 through which the exposure light EL advances to an environment of a prescribed status. The chamber apparatus 6 comprises a first member 7, which forms a first space 5 through which the exposure light EL advances, and a first adjustment apparatus 8, which adjusts the environment of the first space 5. In the present embodiment, the first adjustment apparatus 8 includes a vacuum system and adjusts the first space 5 to a vacuum status. The control apparatus 4 uses the first adjustment apparatus 8 to adjust the first space 5 through which the exposure light EL advances to a near vacuum status. As an example, in the present embodiment, the pressure of the first space 5 is adjusted to a reduced pressure atmosphere of approximately 1×10⁻⁴ Pa.

The exposure light EL that has emerged from the light source apparatus 3 advances through the first space 5. In the present embodiment, at least a part of the illumination optical system IL and a projection optical system PL are arranged in the first space 5. The exposure light EL that has emerged from the light source apparatus 3 passes through the illumination optical system IL and the projection optical system PL arranged in the first space 5. In addition, in the present embodiment, a substrate stage 2 is arranged in the first space 5.

In the present embodiment, the first member 7 has a first opening 9 and a first surface 11 provided in the vicinity of the first opening 9. The first opening 9 is formed at a position at which the exposure light EL that has advanced through the first space 5 can be incident. In present embodiment, the first opening 9 is formed at a position at which the exposure light EL that has emerged from the illumination optical system IL can be incident.

The mask stage 1 is arranged so as to cover the first opening 9. The mask stage 1 has a second surface 12 that opposes the first surface 11, and it is capable of relative movement with respect to the first opening 9 while being guided by the first surface 11. In the present embodiment, a gas seal mechanism 10 is formed between the first surface 11 of the first member 7 and the second surface 12 of the mask stage 1. In the present embodiment, a prescribed gap G1 is formed between the first surface 11 and the second surface 12. The gap G1 is adjusted to a prescribed amount (for example, approximately 0.1 to 1 μm), and the gas is restricted from flowing into the inside of the first space 5 via the gap G1. In the present embodiment, the first opening 9 is covered by the mask stage 1, and by forming a gas seal mechanism 10 between the first surface 11 of the first member 7 and the second surface 12 of the mask stage 1, the first space 5 comes to a status in which it is substantially sealed. Through this, the chamber apparatus 6 is able to control the first space 5 to a prescribed status (vacuum status).

The mask stage 1 holds the mask M so that the mask M is arranged in the first space 5 via the first opening 9. In the present embodiment, the mask stage 1 is arranged at the +Z side of the first space 5, and it holds the mask M so that reflecting surface of the mask M faces the −Z side (the first space 5 side). In addition, in the present embodiment, the mask stage 1 holds the mask M so that the reflecting surface of the mask M and the XY plane are substantially parallel. The exposure light EL that has emerged from the illumination optical system IL is incident to the reflecting surface of the mask M held by the mask stage 1.

In the present embodiment, the mask stage 1 includes a first stage 13, which is larger than the first opening 9 and on which the second surface 12 is formed, and a second stage 14, which is smaller than the first opening 9 and is able to move with respect to the first stage 13 while holding the mask M. The first stage 13 is arranged so as to cover the first opening 9, and a gas seal mechanism 10 is formed between the second surface 12 of the first stage 13 and the first surface 11 of the first member 7. The first stage 13 is able to move with respect to the first opening 9 while being guided by the first surface 11. The second stage 14 is arranged at the −Z side (the first space 5 side) of the first stage 13. The mask M that is held by the second stage 14 is arranged in the first space 5 via the first opening 9. The second stage 14 is able to move with respect to the first stage 13 in a status in which the mask M is held.

In addition, in the present embodiment, the chamber apparatus 6 comprises a second member 16, which forms a second space 15 that accommodates the mask stage 1 in the space between itself and the outer surface of the first member 7, and a second adjustment apparatus 17, which adjusts the environment of the second space 15. In the present embodiment, the outside of the first space 5 and the second space 15 is an atmospheric space, and the pressure of the space outside the first space 5 and the second space 15 is atmospheric pressure. The second adjustment apparatus 17 adjusts the second space 15 to a pressure that is higher than the pressure of the first space 5 and lower than atmospheric pressure. As an example, in the present embodiment, the pressure of the second space 15 is adjusted to approximately 1×10⁻¹ Pa.

Alternatively, the first adjustment apparatus 8 and the second adjustment apparatus 17 can be combined to be commoditized. For example, in one embodiment, a first passage from the adjustment apparatus to the first space 5 and a second passage from the adjustment apparatus to the second space 15 are provided, and the adjustment apparatus can be in interchangeable communication with one of the passages. In this case, the adjustment target can be switched so that the first space 5 is set to be in a predetermined pressure by the adjustment apparatus and then the second space 15 is set to be in a predetermined pressure. Alternatively, the adjustment target can be switched so that the second space 15 is set to be in a predetermined pressure by the adjustment apparatus and then the first space 5 is set to be in a predetermined pressure.

Specifically, in the present embodiment, at least a part of the mask stage 1 is arranged in the second space 15, and the mask M that is held by the mask stage 1 is arranged in the first space 5.

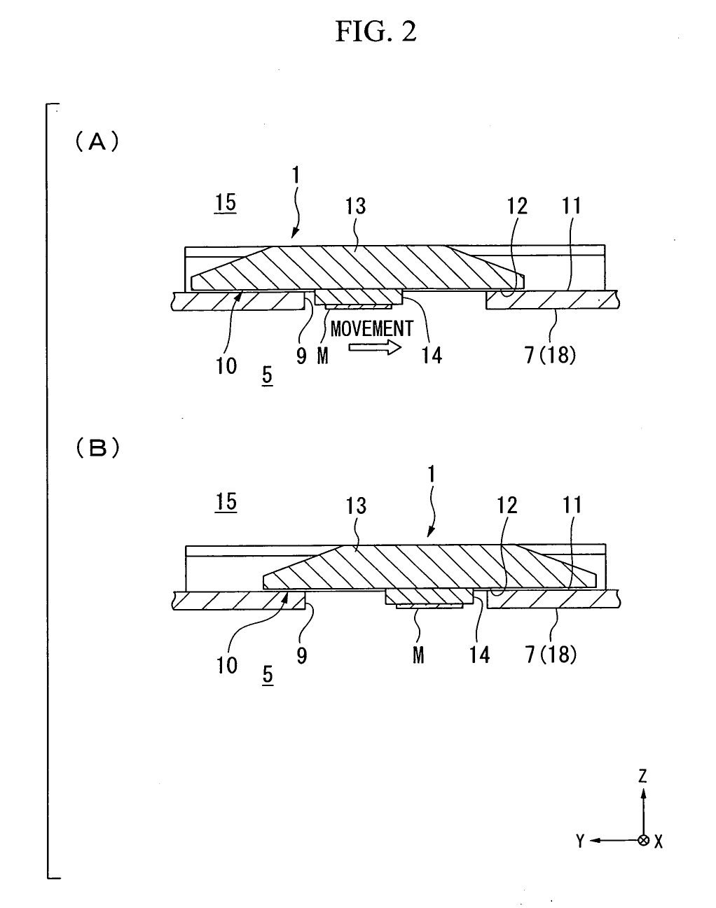

FIG. 2 is a schematic drawing for explaining an example of the operation of the mask stage 1. The exposure apparatus EX of the present embodiment is a scanning exposure apparatus (a so-called scanning stepper) that synchronously moves the mask M and the substrate P in a prescribed scanning direction while projecting the image of the pattern of the mask M to the substrate P. In the present embodiment, the scanning direction (synchronous movement direction) of the mask M is the Y axis direction, and the scanning direction (synchronous movement direction) of the substrate P is also the Y axis direction. The exposure apparatus EX moves the shot region of the substrate P in the Y axis direction with respect to the projection area of the projection optical system PL while moving the pattern formation area of the mask M in the Y axis direction with respect to the illumination area of the illumination system IL in synchronization with the movement of the shot region of the substrate P in the Y axis direction while illuminating the mask M with exposure light EL and irradiating the exposure light EL from the mask M to the substrate P to expose the substrate P.

As shown in FIG. 2, the mask stage 1 is able to move while holding the mask M so that the mask M is arranged in the first space 5 via the first opening 9. In the present embodiment, the first stage 13 is able to move in at least the Y axis direction while being guided by the first surface 11.

The first stage 13 has a relatively large stroke in the Y axis direction (scanning direction) so that the entire pattern formation region of the mask M passes through the illumination area of the illumination optical system IL during scanning exposure of the first shot region on the substrate P. By the first stage 13 moving in the Y axis direction, the second stage 14, which is supported by the first stage 13, also moves in the Y axis direction along with the first stage 13. Therefore, by the first stage 13 moving in the Y axis direction, the mask M that is held by the second stage 14 also moves in the Y axis direction along with the first stage 13. The second stage 14 is able to move slightly with respect to the first stage 13.

When the substrate P is exposed, the control apparatus 4 controls the mask stage 1 to move the mask M, which is held by the mask stage 1, to the exposure start position (scanning start position). In part (A) of FIG. 2, a status in which the mask M is arranged at the exposure start position is shown. Then, the control apparatus 4 moves the mask stage 1 in the Y axis direction (here, the −Y direction) while emitting exposure light EL by means of the illumination optical system IL and causes a transition from the status shown in part (A) of FIG. 2 to the status shown in part (B) of FIG. 2. In part (B) of FIG. 2, a status in which the mask M is arranged at the exposure end position (scanning end position) is shown.

In the present embodiment, a gas seal mechanism 10 is formed between the first surface 11 of the first member 7 and the second surface 12 of the first stage 13, and it is possible to restrict gas from flowing into the inside of the first space 5 even in the case in which the first stage 13 has moved with respect to the first member 7. In addition, as discussed below, in the present embodiment, a gap adjustment mechanism that adjusts the gap G1 between the first surface 11 and the second surface 12 is provided, and the gap G1 between the first surface 11 and the second surface 12 can be maintained at the prescribed amount even in a status in which the first stage 13 is moving with respect to the first member 7. Through this, it is possible to restrict gas from flowing into the inside of the first space 5 even in the case in which the first stage 13 has moved with respect to the first member 7.

Next, each of the respective elements discussed above will be described while referring to FIG. 1.

In the present embodiment, the first member 7 includes a guide member 18 on which the first surface 11 is formed and a chamber member 19 that opposes at least a part of the guide member 18. The guide member 18 guides the movement of the mask stage 1. The mask stage 1 moves with respect to the first opening 9 while being guided by the first surface 11 of the guide member 18.

In addition, the chamber apparatus 6 has a bellows member 20 that connects the guide member 18 and the chamber member 19. The bellows member 20 has flexibility and is capable of elastic deformation. In the present embodiment, the bellows member 20 is made of metal. As an example, the bellows member 20 of the present embodiment is made of stainless steel. Stainless steel has low outgas. For this reason, it is possible to restrict the effects that the bellows member 20 has on the first space 5.

In the present embodiment, the first member 7 includes the guide member 18, the chamber member 19 and the bellows member 20. A nearly sealed first space 5 is formed by means of the guide member 18, the chamber member 19, the bellows member 20 and the mask stage 1.

In the present embodiment, the exposure apparatus EX comprises a base member 21 and a first support member 23 supported on the base member 21 via a first vibration proofing system 22. The chamber member 19 is supported by a first support member 23. In addition, a first frame member 24 is arranged on the base member 21. The first frame member 24 includes a support post part 25 and a support part 26 that is connected to the upper end of the support post part 25. A second support member 27, which supports the lower surface of the guide member 18, is connected onto the support part 26. The chamber member 19 and the second support member 27 are separated from each other. In addition, the chamber member 19 and the first frame member 24 are separated from each other, and a seal mechanism that has flexibility (elasticity), such as a bellows member, is arranged between the chamber member 19 and the first frame member 24. The chamber member 19 has an upper surface 19A that opposes the lower surface 18B of the guide member 18 supported by the second support member 27. The bellows member 20 is arranged so as to connect the lower surface 18B of the guide member 18 and the upper surface 19A of the chamber member 19.

The light source apparatus 3 generates exposure light EL. The light source apparatus 3 of the present embodiment is a laser produced plasma light source apparatus, a so-called LPP light source apparatus, that irradiates laser light to a target material such as xenon (Xe) to plasmify that target material and generate EUV light. Note that the light source apparatus 3 may also be a discharge produced plasma light source apparatus, a so-called DPP light source apparatus, that produces an electric discharge in a prescribed gas to plasmify that prescribed gas and generate EUV light. The EUV light (exposure light EL) generated by the light source apparatus 3 is incident to the illumination optical system IL.

The illumination optical system IL illuminates the mask M using exposure light EL from the light source apparatus 3. The illumination optical system IL includes a plurality of optical elements, and it illuminates a prescribed illumination area on the mask M using exposure light EL with a uniform illumination intensity distribution. The optical elements of the illumination optical system IL include a multilayer film reflecting mirror that comprises a multilayer film that is able to reflect EUV light. The multilayer film of the optical elements includes for example Mo/Si multilayer film.

The first stage 13 of the mask stage 1 is able to move in three directions, which are the X axis, Y axis and OZ axis directions, in a status in which the mask M is held. The second stage 14 of the mask stage 1 is able to move in six directions, which are the X axis, Y axis, Z axis, θX, θY and θZ directions, in a status in which the mask M is held. In present embodiment, a laser interferometer (not shown), which is able to measure position information of the mask stage 1 (the mask M), and a focus leveling detection system (not shown), which is able to detect surface position information of the reflecting surface of the mask M, are provided, and the control apparatus 4 controls the position of the mask M held by the mask stage 1 based on the measurement results of a laser interferometer and the detection results of the focus leveling detection system.

The first stage 13 and the second stage 14 of the mask stage 1 are made of metal. As an example, the first stage 13 and the second stage 14 of the present embodiment are made of stainless steel, which has little outgas.

The projection optical system PL includes a plurality of optical elements and projects the image of a pattern of the mask M to the substrate P at a prescribed projection magnification. The optical elements of the projection optical system PL include a multilayer film reflecting mirror that comprises a multilayer film that is able to reflect EUV light. The multilayer film of the optical elements includes, for example, a Mo/Si multilayer film.

The plurality of optical elements of the projection optical system PL is held by a lens barrel 28. The lens barrel 28 has a flange 29. The lower end of the second frame member 30 is connected to the flange 29. The upper end of the second frame member 30 is connected with the support part 26 of the first frame member 24 via a second vibration proofing system 31. The lens barrel 28 (flange 29) is suspended on the second frame member 30.

The substrate stage 2 holds the substrate P so that the surface (exposure surface) of the substrate P and the XY plane become substantially parallel. In addition, in the present embodiment, the substrate stage 2 holds the substrate P so that the surface of the substrate P faces the +Z direction. The exposure light EL that has emerged from the projection optical system PL is irradiated to substrate P held by the substrate stage 2.

The substrate stage 2 is able to move in six directions, which are the X axis, Y axis, Z axis, θX, θY and θZ directions, in a status in which the substrate P is held. In the present embodiment, a laser interferometer (not shown), which is able to measure position information of the substrate stage 2 (the substrate P), and a focus leveling detection system (not shown), which is able to detect surface position information of the surface of the substrate P, are provided, and the control apparatus 4 controls the position of the substrate P held by the substrate stage 2 based on the measurement results of the laser interferometer and the detection results of the focus leveling detection system.

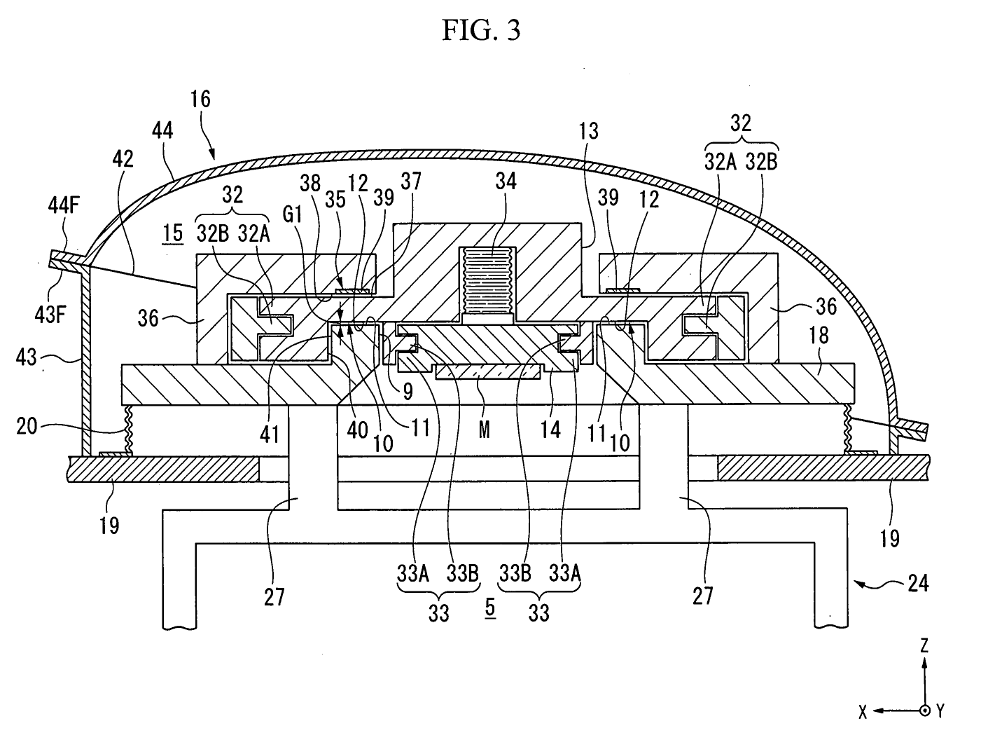

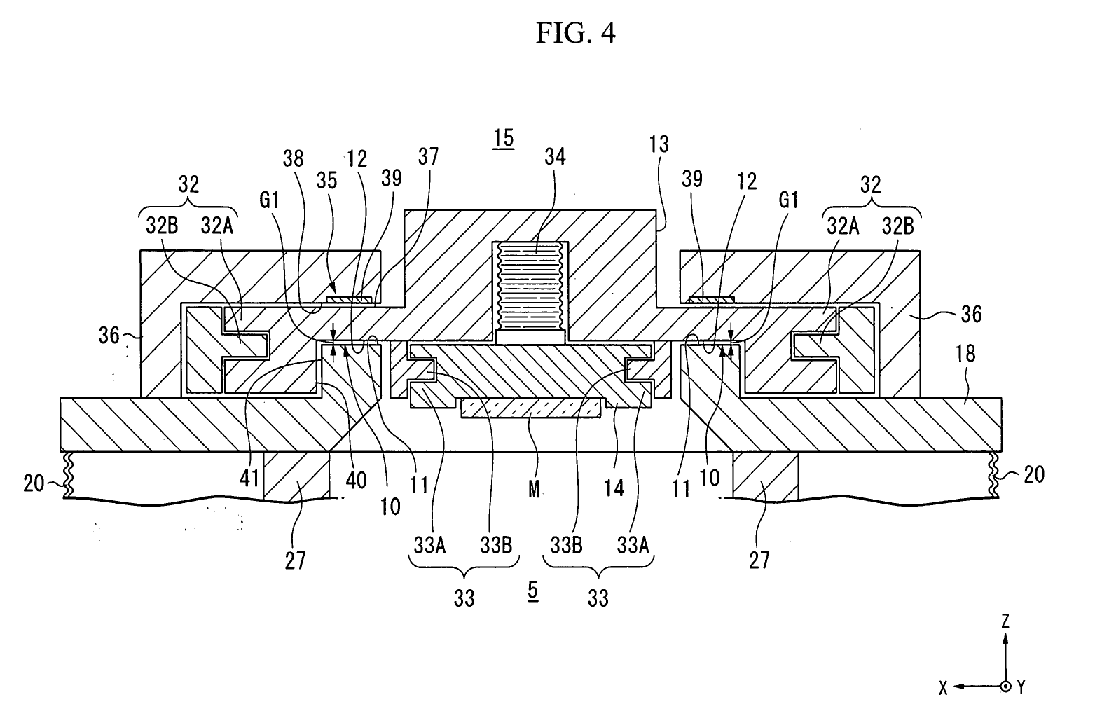

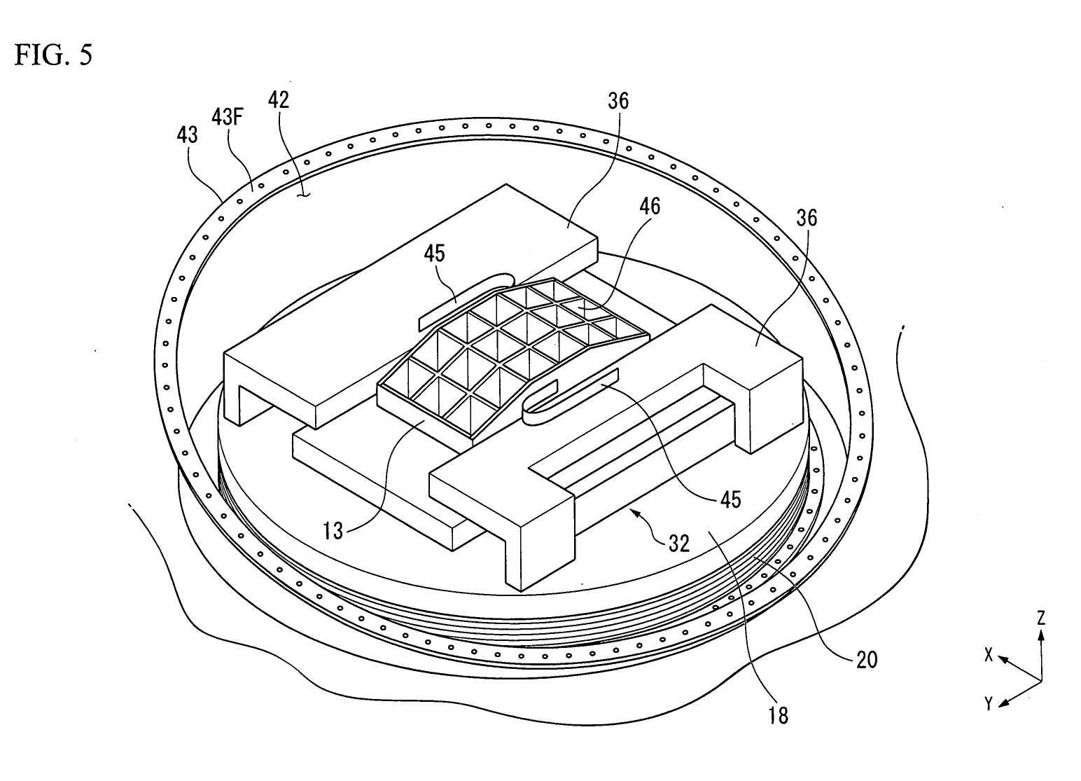

FIG. 3 is a cross-sectional view parallel with XZ plane that shows the vicinity of the mask stage 1, FIG. 4 is a drawing that enlarges a part of FIG. 3, and FIG. 5 is an oblique view that shows the vicinity of the mask stage 1.

In FIG. 3, FIG. 4 and FIG. 5, the exposure apparatus EX comprises a first stage drive apparatus 32 for moving the first stage 13 in the Y axis direction. The first stage drive apparatus 32 includes an actuator such as a linear motor. In the present embodiment, the first stage drive apparatus 32 has movers 32A provided at both sides of the X axis direction of the first stage 13 and stators 32B provided to correspond to the movers 32A. The control apparatus 4 is able to move the first stage 13 in the Y axis direction using the first stage drive apparatus 32.

In present embodiment, each stator 32B is arranged on the guide member 18. A gas bearing is arranged between the stator 32B and the guide member 18, and the stator 32B is supported without contact with respect to the guide member 18. For this reason, the stator 32B moves in the −Y direction (+Y direction) to correspond to the movement of the first stage 13 in the +Y direction (−Y direction) according to the law of conservation of momentum. Through this movement of the stator 32B, it is possible to restrict changes in center of gravity position while the reaction force accompanying the movement of the first stage 13 is offset. Specifically, in the present embodiment, the stator 32B functions as a so-called countermass.

In addition, the exposure apparatus EX comprises a second stage drive apparatus 33 for moving the second stage 14 with respect to the first stage 13. The second stage drive apparatus 33 includes an actuator such as a voice coil motor. In the present embodiment, the second stage drive apparatus 33 has a mover 33A provided on the second stage 14 and stators 33B provided to correspond to the movers 33A. Each stator 33B is connected to the lower surface of the first stage 13. The control apparatus 4 is able to move the second stage 14 in the X axis, Y axis, Z axis, θX, θY and θZ directions with respect to the first stage 13 using the second stage drive apparatus 33.

In addition, in the present embodiment, a dead weight cancellation mechanism 34, which cancels the dead weight of the second stage 14 that acts in the Z axis direction, is arranged between the first stage 13 and the second stage 14. The dead weight cancellation mechanism 34 includes, for example, a bellows member.

Furthermore, the exposure apparatus EX comprises gap adjustment mechanisms 35, which adjust the gap G1 between each first surface 11 of the guide member 18 and each second surface 12 of the first stage 13. In the present embodiment, the gap adjustment mechanism 35 adjusts the gap G1 between the first surface 11 and the second surface 12 using electromagnetic force.

In present embodiment, fixed members 36 are arranged on the guide member 18. Each fixed member 36 has a lower surface 38 that opposes the upper surface 37 of the first stage 13, which is the side opposite the second surface 12 (lower surface). Each gap adjustment mechanism 35 includes an electromagnet unit 39 arranged at the lower surface 38 of each fixed member 36. The gap adjustment mechanism 35 is able to adjust the force (attraction force) generated between the lower surface 38 of the fixed member 36 and the upper surface 37 of the first stage 13 by adjusting the electric power (electric current) supplied to the electromagnetic unit 39. The gap adjustment mechanism 35 is able to adjust the gap G1 between the first surface 11 and the second surface 12 by adjusting the force that is generated between the lower surface 38 of the fixed member 36 and the upper surface 37 of the first stage 13.

There is a case where eddy current is generated by the electromagnetic force of the gap adjustment mechanism 35 along with the movement of the first stage 13, and it may affect the position control for the first stage 13 or the like. In order to reduce the affection, the lower surface 38 of the fixed member 36 and/or the upper surface 37 of the first stage 13 can comprise laminated steel plate to suppress the generation of the eddy current. An aspect for reducing the affection by the eddy current is disclosed in, for example, U.S. Patent Application Publication No. 2008/0073982, etc.

The gap adjustment mechanism 35 can be configured to adjust the gap G1 between the lower surface 38 of the fixed member 36 and the upper surface 37 of the first stage 13 by use of another means other than the electromagnetic force.

Note that, in the first embodiment, it is possible to arrange a differential exhaust gas bearing between the first surface 11 and the second surface 12. Through this, it is possible to weaken the force that the gap adjustment mechanism 35 requires.

It is not limited that the gap adjustment mechanism 35 is arranged at the lower surface 38 of the fixed member 36. For example, it can be arranged at adjacent to the side of the first surface 11 of the guide member 18.

Note that it is possible to provide an adjustment mechanism that adjusts the gap between each inside surface 40 of the first stage 13, which is substantially perpendicular to the X axis, and each outside surface 41 of the guide member 18, which opposes each of those inside surfaces 40. For example, by arranging an electromagnetic unit at the outside surface 41 and adjusting the electric power supplied to the electromagnet unit, it is possible to adjust the force that occurs between the inside surface 40 of the first stage 13 and the outside surface 41 of the guide member 18 to adjust the gap between the inside surface 40 and the outside surface 41. Through this, it is possible to adjust the position of the first stage 13 in the X axis direction. Note that a differential exhaust air bearing may also be arranged between the inside surface 40 and the outside surface 41 to adjust the gap between the inside surface 40 and the outside surface 41.

In addition, it is possible to adjust the position of the first stage 13 in the θZ axis direction by varying the amount of drive resulting from the mover 32A and the stator 32B arranged at the +X side of the first stage 13 and the amount of force resulting from the mover 32A and the stator 32B arranged at the −X side of the first stage 13. Also, it is possible to arrange an actuator such as a voice coil motor between the lower surface of the first stage 13 and the upper surface of the second stage 14 to move the second stage 14 in the Z axis, θX and θY directions with respect to the first stage 13.

As shown in FIG. 3 and FIG. 5, the second member 16 includes a main body member 43, which is connected to the upper surface of the chamber member 19 and has a second opening 42, and a lid member 44, which is attachable and removable with respect to the main body member 43 and covers the second opening 42. The second space 15, which is nearly sealed, is formed by the main body member 43 and the lid member 44 being connected. In addition, the second space 15 is opened by removing the lid member 44 from the main body member 43.

In the present embodiment, the first stage 13, the first stage drive apparatuses 32 and the gap adjustment mechanisms 35 are arranged in the second space 15. As shown in FIG. 5, cables 45 for supplying motive power (electric power, etc.) to, for example, each first stage drive apparatus 32, each second stage drive apparatus 33 and each gap adjustment mechanism 35 are also arranged in the second space 15. In the present embodiment, the cable 45 is supported by a so-called cable bearing. Through this, for example, workers are able to easily access the respective equipment and members arranged in the second space 15 by removing the lid member 44 from the main body member 43.

In addition, in the present embodiment, the main body member 43 has a first flange 43F, and the lid member 44 has a second flange 44F that is able to oppose the first flange 43F. By connecting the first flange 43F and the second flange 44F by means of, for example, bolts, the main body member 43 and the lid member 44 are connected, and a sealed second space 15 is formed. In the present embodiment, the first flange 43F of the main body member 43 is inclined with respect to the XY plane, so workers are able to easily access the respective equipment, members, etc. arranged in the second space 15. Also, by inclining the first flange 43F with respect to the XY plane, it is also possible to smoothly implement work when removing the respective equipment, members, etc. arranged in the second space 15 or when attaching the respective equipment, members, etc. in the second space 15.

Note that, as shown in FIG. 5, a plurality of notches is formed and ribs 46 are formed on the upper surface of the first stage 13. Through this, lightening of the first stage 13 is realized while strength is maintained.

Next, an example of operation of an exposure apparatus EX having the configuration discussed above will be described.

The first space 5 is adjusted to a vacuum status by means of the first adjustment apparatus 8. Furthermore, the second space 15 is adjusted to substantially the same pressure as that of the first space 5 by means of the second adjustment apparatus 17 or it is adjusted to a pressure that is higher than that of the first space 5 and lower than atmospheric pressure. Or, the second space 15 may be set to a pressure that is lower than that of the first space 5. The gap G1 between the first surface 11 and the second surface 12 is adjusted to a prescribed amount by means of the gap adjustment mechanism 35, and gas is restricted from flowing into the inside of the first space 5 by means of the gas seal mechanism 10 formed between the first surface 11 and the second surface 12. Through this, the vacuum status and the environment of the first space 5 are maintained.

After the substrate P has been held by the substrate stage 2 while the mask M is held by the mask stage 1, the control apparatus 4 starts exposure processing of the substrate P. In order to illuminate the mask M using exposure light EL, the control apparatus 4 starts the light emission operation of the light source apparatus 3.

The exposure light EL that has emerged from the light source apparatus 3 by means of the light emission operation of the light source apparatus 3 is incident to the illumination optical system IL. The exposure light EL that is incident to the illumination optical system IL is supplied to the first opening 9 after it has been transmitted through the illumination optical system IL. The exposure light EL that has been supplied to the first opening 9 is incident to the mask M that is held by the mask stage 1 via the first opening 9. The mask M that is held by the mask stage 1 is illuminated by the exposure light EL (EUV light) that has emerged from the light source apparatus 3 and has passed through the illumination optical system IL. The exposure light EL that has been irradiated to the reflecting surface of the mask M and has been reflected by that reflecting surface is incident to the projection optical system PL, which is arranged in the first space 5. The exposure light EL that has entered the projection optical system PL is irradiated to the substrate P that is held by the substrate stage 2 after it has been transmitted through the projection optical system PL.

The control apparatus 4 moves the substrate P in the Y axis direction synchronously with the movement of the mask M in the Y axis direction while illuminating the mask M using the exposure light EL. Through this, the substrate P is exposed by the exposure light EL, and the image of the pattern of the mask M is projected to the substrate P.

As described above, through the present embodiment, it is possible to restrict changes in the environment of the first space 5 by means of the gas seal mechanism 10, and it is possible to adjust the first space 52 to a prescribed status (vacuum status). Therefore, it is possible to restrict the exposure light EL that advances through the first space 5 from attenuating and to restrict the optical elements (multilayer film reflecting mirror) arranged in the first space 5 from becoming soiled. Therefore, it is possible to maintain the performance of the exposure apparatus EX, and it is possible to expose the substrate P well.

In addition, through the present embodiment, at least a part of the first stage 13, the first stage drive apparatuses 32, etc. are arranged in a space outside the first space 5, so it is possible to smoothly implement adjustment processing, maintenance processing, etc. of the first stage 13, the first stage drive apparatuses 32, etc. In the case in which the entire mask stage 1 is arranged in the first space 5, in order to implement adjustment processing, maintenance processing, etc. of the mask stage 1, there is a possibility that it will be necessary to first open the first space 5 and release the vacuum status of the first space 5. In that case, after the adjustment processing, maintenance processing, etc. has ended, processing to return the first space 5 to a vacuum status, such as exhaust processing of the first space 5, becomes necessary. Such processing requires time, and, as a result, there is a possibility that the operation rate of the exposure apparatus EX will decrease. In the present embodiment, at least a part of the mask stage 1 is arranged in a space outside the first space 5, so it is possible to smoothly implement adjustment processing, maintenance processing, etc. of the mask stage 1 while maintaining the vacuum status of the first space 5. Therefore, it is possible to restrict decreases in the operation rate of the exposure apparatus EX.

In addition, when a member that has a possibility of generating outgas, such as a cable 45, is arranged in the first space 5, there is a possibility that the environment of the first space 5 will change, the exposure light EL will attenuate, and an the optical elements (multilayer film reflecting mirror) arranged in the first space 5 will become soiled. Through the present embodiment, members that have a possibility of generating outgas are arranged in a space outside the first space 5, so it is possible to maintain the first space 5 in a prescribed status, and it is possible to restrict decreases in the performance of the exposure apparatus EX. Also, a member such as a cable 45 need not be arranged in the first space 5, so it is possible to increase the degree of freedom of selection of the material of those members and to increase the degree of freedom of the design of those members.

In addition, due to the fact that gap adjustment mechanisms 35 that adjust the gap G1 between each first surface 11 and each second surface 12 are provided, even in the case in which the second surface 12 of the mask stage 1 is moved with respect to the first surface 11 of the first member 7, it is possible to restrict gas from flowing into the inside of the first space 5 via the gap G1. Also, the gap adjustment mechanism 35 adjusts the gap G1 using electromagnetic force, so it is possible to maintain the gap G1 at a prescribed amount to restrict gas from flowing into the inside of the first space 5 even if, for example, the movement velocity of the mask stage 1 (the first stage 13) is increased to a high speed.

In addition, by connecting the guide member 18, which guides the movement of the mask stage 1, and the chamber member 19 using a bellows member 20, it is possible to restrict displacement (deformation) of the chamber member 19 from being transmitted to the guide member 18. For example, even if the chamber member 19 becomes displaced (deformed) due to a pressure change of the first space 5, it is possible to restrict displacement (deformation) of the chamber member 19 from being transmitted to the guide member 18. Therefore, it is possible to maintain the gap G1 between the first surface 11 of the guide member 18 and the second surface 12 of the mask stage 1 at the prescribed amount.

In addition, by providing a second member 16, which forms a second space 15 that accommodates the mask stage 1 in the space between itself and the outer surface of the first member 7, it is possible to protect the mask stage 1. So, by adjusting the second space 15 to a pressure that is lower than atmospheric pressure, it is possible to reduce the pressure differential between the first space 5 and the second space 15, in which the mask stage 1 is arranged. In the case in which the pressure differential between the first space 5 and the second space 15 is large, there is a possibility that, due to the pressure differential, the first stage 13 will be pressed against the guide member 18 and it will be difficult to maintain the gap G1 between the first surface 11 of the guide member 18 and the second surface 12 of the first stage 13 at the prescribed amount. Through the present embodiment, by adjusting the pressure of the second space 15 according to the pressure of the first space 5, it is possible to maintain the gap G1 between the first surface 11 and the second surface 12 at the prescribed amount.

As described above, the pressure differential acting on the guide member 18 corresponds to the pressure differential between the first space 5 and the second space 15, and can be lower than the pressure differential, which acts on the chamber member 19, between the first space and the atmospheric space. As a result, the strength of the guide member 18 (e.g., the strength per unit area) can be less than the strength of the chamber member 19.

In addition, the pressure differential acting on the lid member 44 can be less than that on the chamber member 19, therefore, the required strength of the lid member 44 can be diminished. As a result, lightening of the lid member 44 can be realized, then, for example, it is possible to lessen the burden for detaching the lid member 44 at the maintenance operation.

Note that, in the present embodiment, if it is possible to maintain the gap G1 between the first surface 11 and the second surface 12 at the prescribed amount by means of, for example, the gap adjusting mechanism 35, even if the pressure of the space in which the first stage 13 is arranged is atmospheric pressure, adjustment processing by means of the second adjustment mechanism 17 may be eliminated, and the second member 16 for forming the second space 15 may be omitted.

Note that, in the present embodiment, the case in which the exposure light EL is EUV light was described as an example, but, for the exposure light EL, it is also possible to use, for example, deep ultraviolet light (DUV light) such as bright lines (g line, h line, line) that emerge from a mercury lamp and KrF excimer laser light (wavelength of 248 nm) or vacuum ultraviolet light (VUV light) such as ArF excimer laser light (wavelength of 193 nm) and F₂ laser light (wavelength of 157 nm). In such a case, there is no absolute need for the first space 5 to be adjusted to a vacuum status, and, for example, it is possible to fill the first space 5 with a first gas. In a case in which the first space 5 is filled with a first gas, it is possible to use the gas seal mechanism 10 of the present embodiment in order to maintain the environment of the first space 5 into which the first gas has been filled. In addition, the second space 15, which is formed by the second member 16, can be filled with a second gas.

### Second Embodiment

Next, the second embodiment will be explained. Identical symbols are assigned for constituent portions that are identical or similar to those of the embodiment discussed above, and explanations thereof will be abbreviated or omitted.

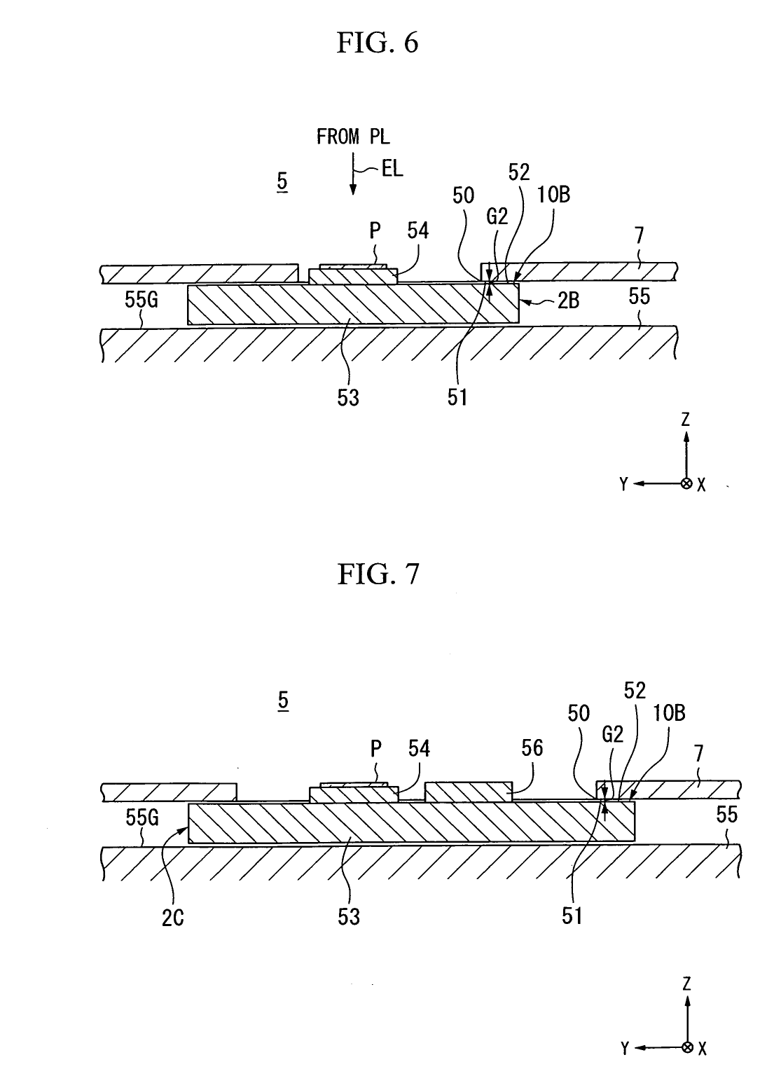

FIG. 6 is a schematic view that shows the second embodiment. In the first embodiment discussed above, the case in which the first opening 9, which is formed at a position at which the exposure light EL can be incident, is covered by the mask stage 1 was described as an example, but the characteristic portion of the second embodiment is the point that a third opening 50 formed at the prescribed position of the first member 7 at which the exposure light EL can be incident is covered by the substrate stage 2B.

In FIG. 6, the first member 7 has a third opening 50 and a third surface 51 provided in the vicinity of the third opening 50. The third opening 50 is formed at a position at which the exposure light EL that has advanced through the first space 5 can be the incident. In the present embodiment, the third opening 50 is formed at a position at which the exposure light EL that has emerged from the projection optical system PL can be incident.

The substrate stage 2B is arranged so as to cover the third opening 50. The substrate stage 2B has a fourth surface 52 that opposes the third surface 51, and relative movement with respect to the third opening 50 is possible. In the present embodiment, a gas seal mechanism 10B is formed between the third surface 51 of the first member 7 and the fourth surface 52 of the substrate stage 2B. A prescribed gap G2 is formed between the third surface 51 and the fourth surface 52, and gas is restricted from flowing to the inside of the first space 5 via the gap G2.

The substrate stage 2B holds the substrate P so that the substrate P is arranged in the first space 5 via the third opening 50. In the present embodiment, the substrate stage 2B is arranged at the −Z side of the first space, and the substrate stage 2B holds the substrate P so that the surface of the substrate P faces the +Z side (first space 5 side). In addition, in the present embodiment, the substrate stage 2B holds the substrate stage P so that surface of the substrate P and the XY plane become substantially parallel. The exposure light EL that has emerged from the projection optical system PL is irradiated to the surface of the substrate P held by the substrate stage 2B.

In the present embodiment, the substrate stage 2B includes a stage 53 that is larger than the third opening 50 and on which a fourth surface 52 is formed, and a fourth stage 54 that is smaller than the third opening 50 and that is able to move with respect to the third stage 53 while holding the substrate P. The third stage 53 is arranged so as to cover the third opening 50, and a gas seal mechanism 10B is formed between the fourth surface 52 of the third stage 53 and the third surface 51 of the first member 7. The third stage 53 maintains the gap G2 between the third surface 51 and the fourth surface 52 and is able to move with respect to the third opening 50. In the present embodiment, a guide member 55 that has a guide surface 55G that guides the movement of the third stage 53 is provided. The third stage 53 is guided by the guide surface 55G and the third surface 51 while moving within the XY plane. The fourth stage 54 is arranged at the +Z side (the first space 5 side) of the third stage 53. The substrate P held by the fourth stage 54 is arranged in the first space 5 via the third opening 50. The fourth stage 54 is able to move with respect to the third stage 53 in a status in which the substrate P is held.

In addition, though not shown, in the space with respect to the outer surface of the first member 7, a space forming member that forms a space that accommodates the third stage 53 and an adjustment apparatus that adjusts the environment of the space are provided. The adjustment apparatus adjusts the space in which the third stage 53 is accommodated to a pressure that is lower than atmospheric pressure. Note that it is possible to omit adjustment processing by an adjustment apparatus or omit the space forming member.

According to the present embodiment, at least a part of the substrate stage 2B is arranged in a space outside the first space 5, so it is possible to smoothly implement adjustment processing, maintenance processing, etc. of the substrate stage 2B while the vacuum status of the first space 5 is maintained. Therefore, it is possible to restrict decreases in the operation rate of the exposure apparatus EX.

Note that, in the present embodiment, even in the case in which, for example, the first space 5 has been filled with a first gas, it is possible to use the gas seal mechanism 10B of the present embodiment to maintain the environment of the first space 5 into which the first gas has been filled.

Note that, as shown in FIG. 7, a substrate stage 2C may have a fifth stage 56 into which the prescribed measuring instruments have been built. The substrate stage 2C has a built-in measuring instrument so that the prescribed measuring instrument is arranged in the first space 5. Examples of the measuring instrument are a light quantity measuring instrument, which is able to measure the light quantity of the exposure light EL (including the light quantity distribution), an aerial image measuring instrument, which is able to measure the aerial image of the projection optical system PL, and a wave front aberration measuring instrument, which is able to measure the wave front aberration of the projection optical system PL. In addition, the fifth stage 56 may also have a built-in measuring member on which a fiducial mark has been formed.

The control apparatus 4 is able to control the third stage 53 and the fifth stage 56 to arrange the measuring instrument of the fifth stage 56 at a position at which the exposure light EL that has emerged from the projection optical system PL is irradiated. Through this, it is possible to measure the light quantity of the exposure light EL that has emerged from the projection optical system PL, the aerial image of the projection optical system PL, the wave front aberration, etc. using the measuring instruments.

Note that an example of a technology relating to an exposure apparatus that comprises a stage into which a measuring instrument (measuring member) has been built is disclosed in, for example, Japanese Patent Application Publication No. 11-135400 A (corresponding PCT International Publication No. 1999/23692), U.S. Pat. No. 6,897,963, etc.

In addition, two (a plurality of) stages that are able to hold the substrate P and move may be arranged on the third stage 53. Note that an example of a technology relating to an exposure apparatus (twin stage type exposure apparatus) comprising two (a plurality of) stages that are able to hold the substrate P and move is disclosed in, for example, U.S. Pat. No. 6,341,007, U.S. Pat. No. 6,400,441, U.S. Pat. No. 6,549,269, U.S. Pat. No. 6,590,634, U.S. Pat. No. 6,208,407 and U.S. Pat. No. 6,262,796.

Note that, in the first and second embodiments discussed above, an example of the case in which the space outside the first space 5 and the second space 15 is an atmospheric space at atmospheric pressure was described, but it may also be a lower pressure or a higher pressure than atmospheric pressure. Furthermore, the space outside the first space 5 and the second space 15 may also be a space that has been filled with a gas other than air, for example, nitrogen gas.

Note that applicable as substrate P of the respective embodiments discussed above is not only a semiconductor wafer for the manufacture of semiconductor devices but glass substrates for display devices, ceramic wafers for thin film magnetic heads, or mask or reticle base plates, etc. (synthetic quartz, silicon wafer) used in exposure apparatuses.

Applicable as the exposure apparatus EX are, in addition to step-and-scan system scanning type exposure apparatuses (scanning steppers) that synchronously move the mask M and the substrate P to scan expose the pattern of the mask M, step-and-repeat system projection exposure apparatuses (steppers) that full-field expose the pattern on the mask M in a status in which the mask M and the substrate P have been made stationary and sequentially step move the substrate P.

In addition, in step-and-repeat system exposure, after a reduced image of a first pattern has been transferred onto the substrate P using a projection optical system in a status in which the first pattern and the substrate P have been made substantially stationary, a reduced image of the second pattern may be full-field exposed onto the substrate P so that it is partially superimposed with the first pattern using a projection optical system in a status in which the second pattern and the substrate P have been made substantially stationary (stitch system full-field exposure apparatus). In addition, for the stitch system full-field exposure apparatus, application to a step-and-stitch system exposure apparatus that partially superposes and transfers at least two patterns on the substrate P and sequentially moves the substrate P is also possible.

In addition, as disclosed in U.S. Pat. No. 6,611,316 for example, it is also possible to apply the present invention to an exposure apparatus that synthesizes two mask patterns on the substrate via a projection optical system and double exposes, substantially simultaneously, one shot region on a substrate by a single scanning exposure.

The types of exposure apparatuses EX are not limited to exposure apparatuses for semiconductor device fabrication that expose a semiconductor device pattern on a substrate P but are also widely applicable to exposure apparatuses for the manufacture of liquid crystal display elements and for the manufacture of displays, and exposure apparatuses for the manufacture of thin film magnetic heads, image pickup elements (CCDs), micromachines, MEMS, DNA chips or reticles or masks.

As discussed above, the exposure apparatus EX of the present embodiment is manufactured by assembling various subsystems, including the respective constituent elements presented in the Scope of Patents Claims of the present application, so that the prescribed mechanical precision, electrical precision and optical precision can be maintained. To ensure these respective precisions, performed before and after this assembly are adjustments for achieving optical precision with respect to the various optical systems, adjustments for achieving mechanical precision with respect to the various mechanical systems, and adjustments for achieving electrical precision with respect to the various electrical systems. The process of assembly from the various subsystems to the exposure apparatus includes mechanical connections, electrical circuit wiring connections, air pressure circuit piping connections, etc. among the various subsystems. Obviously, before the process of assembly from these various subsystems to the exposure apparatus, there are the processes of individual assembly of the respective subsystems. When the process of assembly of the various subsystems to the exposure apparatus has ended, overall adjustment is performed, and the various precisions are ensured for the exposure apparatus as a whole. Note that it is preferable that manufacture of the exposure apparatus be performed in a clean room in which the temperature, the degree of cleanliness, etc. are controlled.

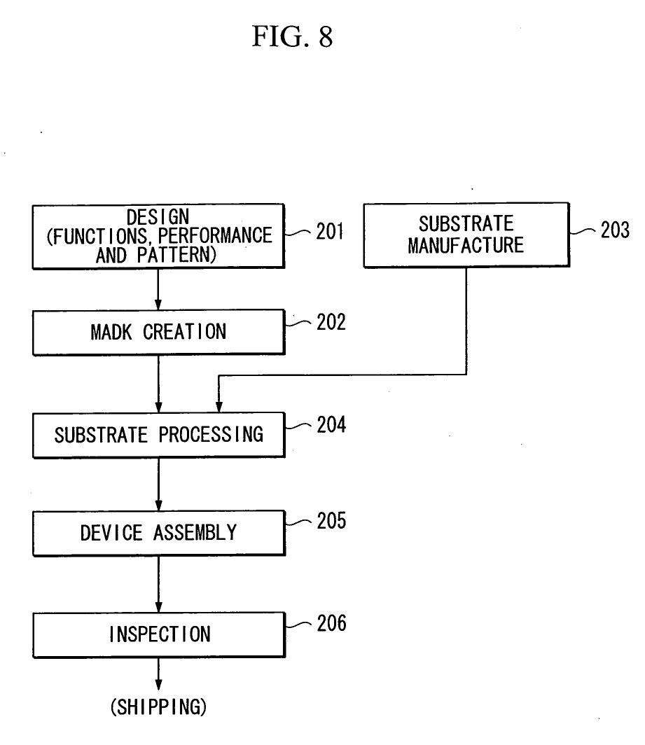

As shown in FIG. 8, microdevices such as semiconductor devices are manufactured by going through a step 201 that performs microdevice function and performance design, a step 202 that creates the mask (reticle) based on this design step, a step 203 that manufactures the substrate that is the device base material, a substrate processing step 204 that includes exposing the image of the pattern of the mask onto a substrate according the embodiments discussed above and developing the exposed substrate, a device assembly step (including processing processes such as the dicing process, bonding process and packaging process) 205, an inspection step 206, etc.

Note that the disclosures of all public documents and U.S. patents relating to the exposure apparatus, etc. that have been cited in the respective embodiments and modification examples discussed above shall be invoked and considered a part of the descriptions of this document.

Note that embodiments of the present invention have been described as discussed above, but the present invention is such that it is possible that all of the constituent elements discussed above will be appropriately used in combination, and there are also cases in which a part of the constituent elements will not be used.

1. An environment control apparatus comprising:
a first member that forms a first space and at least a part of which a first opening is formed, the first member having a first surface that is provided in the vicinity of the first opening;
a movable member that has a second surface and that is capable of relative movement with respect to the first opening while being guided by the first surface, the second surface being arranged so as to cover the first opening and opposing the first surface; and
a gap adjustment mechanism that adjusts a gap between the first surface and the second surface,
wherein a gas seal mechanism is formed between the first surface and the second surface, and the first space can be set to a prescribed status.

2. An environment control apparatus according to claim 1, wherein the gap adjustment mechanism comprises the gas seal mechanism.

3. An environment control apparatus according to claim 1, wherein the gap adjustment mechanism adjusts the gap using electromagnetic force.

4. An environment control apparatus according to claim 1, wherein
the first member has a guide member on which the first surface is formed and a chamber member that opposes at least a part of the guide member, and
the environment control apparatus further comprises a bellows member that connects the guide member and the chamber member.

5. An environment control apparatus according to claim 1, further comprising a first adjustment apparatus that adjusts the environment of the first space.

6. An environment control apparatus according to claim 5, wherein the first adjustment apparatus adjusts the first space to a vacuum status.

7. An environment control apparatus according to claim 1, further comprising a second member that forms a second space, the movable member being disposed in the space between the second member and the outer surface of the first member.

8. An environment control apparatus according to claim 7, further comprising a second adjustment apparatus that adjusts the environment of the second space.

9. An environment control apparatus according to claim 8, wherein
the outside of the second space comprises atmospheric space, and
the second adjustment apparatus adjusts the second space to a pressure that is lower than atmospheric pressure.

10. An environment control apparatus according to claim 9, wherein the second adjustment apparatus adjusts the second space to a pressure that is higher than the pressure of the first space and lower than atmospheric pressure.

11. An environment control apparatus according to claim 1, wherein the movable member moves while holding the object so that a prescribed object is arranged in the first space.

12. An environment control apparatus according to claim 11, wherein the movable member comprises
a first movable member that is larger than the first opening and on which the second surface is formed, and
a second movable member that is smaller than the first opening and is able to move with respect to the first movable member while holding the object.

13. An environment control apparatus according to claim 11, wherein the object comprises a mask on which a pattern is formed.

14. An environment control apparatus according to claim 11, wherein the object comprises a photosensitive substrate.

15. An environment control apparatus according to claim 1, wherein
exposure light that has advanced through the first space can be incident into the first opening.

16. A stage apparatus that is able to move while holding an object, comprising:
a movable member that is able to move while holding the object so that the object is arranged in a first space via a first opening formed at least a part of the first member, which forms the first space; and
a gas seal mechanism that has a first surface and a second surface and that forms a gas seal by means of the first surface and the second surface, the first surface being provided in the vicinity of the first opening of the first member, the second surface being provided on the movable member so as to oppose the first surface, relative movement between the first surface and the second surface being allowed.

17. A stage apparatus according to claim 16, further comprising a gap adjustment mechanism that adjusts the gap between the first surface and the second surface.

18. A stage apparatus according to claim 17, wherein the gap adjustment mechanism comprises the gas seal mechanism.

19. A stage apparatus according to claim 17, wherein the gap adjustment mechanism adjusts the gap using electromagnetic force.

20. A stage apparatus according to claim 16, wherein the movable member moves while holding an object to which exposure light is irradiated.

21. A stage apparatus according to claim 20, wherein the object comprises a mask on which a pattern is formed.

22. A stage apparatus according to claim 20, wherein the object comprises a photosensitive substrate.

23. A stage apparatus according to claim 16, wherein the movable member comprises
a first movable member that is larger than the first opening and on which a second surface is formed, and
a second movable member that is smaller than the first opening and able to move with respect to the first movable member while holding the object.

24. A stage apparatus according to claim 16, further comprising
a drive apparatus that comprises a first part and a second part, the first part being connected to the movable member, relative movement between the first part and the second part being allowed, the first part and the second part cooperating with each other to generate a drive force acting on the movable member.

25. A stage apparatus according to claim 24, wherein the second part is disposed external to the first space.

26. A stage apparatus according to claim 24, wherein the first part and the second part can generate the drive force in non-contact state.

27. An exposure apparatus that comprises an environment control apparatus according to claim 1.

28. An exposure apparatus that comprises a stage apparatus according to claim 16.

29. An exposure apparatus that exposes a substrate using exposure light, comprising:
a first member that forms a first space through which the exposure light advances and that has a first opening and a first surface, the first opening being formed at least a part of the first member at which the exposure light which has advanced through the first space can be incident, the first surface being provided in the vicinity of the first opening;
a movable member that has a second surface and that is capable of relative movement with respect to the first opening while being guided by the first surface, the second surface being arranged so as to cover the first opening and opposing the first surface;
a gap adjustment mechanism that adjusts a gap between the first surface and the second surface; and
a gas seal mechanism that is formed between the first surface and the second surface.

30. An exposure apparatus according to claim 29, wherein the gap adjustment mechanism comprises the gas seal mechanism.

31. An exposure apparatus according to claim 29, wherein the gap adjustment mechanism adjusts the gap using electromagnetic force.

32. An exposure apparatus according to claim 29, wherein
the first member has a guide member on which the first surface is formed and a chamber member that opposes at least a part of the guide member, and
the environment control apparatus further comprises a bellows member that connects the guide member and the chamber member.

33. An exposure apparatus according to claim 29, further comprising a first adjustment apparatus that adjusts the environment of the first space.

34. An exposure apparatus according to claim 33, wherein the first adjustment apparatus adjusts the first space to a vacuum status.

35. An exposure apparatus according to claim 29, further comprising a second member that forms a second space, the movable member being accommodated in the space between the second member and an outer surface of the first member.

36. An exposure apparatus according to claim 35, comprising a second adjustment apparatus that adjusts the environment of the second space.

37. An exposure apparatus according to claim 36, wherein
the outside of the second space comprises atmospheric space, and
the second adjustment apparatus adjusts the second space to a pressure that is lower than atmospheric pressure.

38. An exposure apparatus according to claim 37, wherein the second adjustment apparatus adjusts the second space to a pressure that is higher than the pressure of the first space and lower than atmospheric pressure.

39. An exposure apparatus according to claim 29, wherein the movable member moves while holding the object so that a prescribed object is arranged in the first space.

40. An exposure apparatus according to claim 39, wherein the movable member comprises
a first movable member that is larger than the first opening and on which a second surface is formed, and
a second movable member that is smaller than the first opening and is able to move with respect to the first movable member while holding the object.

41. An exposure apparatus according to claim 39, wherein the object comprises a mask on which a pattern is formed.

42. An exposure apparatus according to claim 39, wherein the object comprises a photosensitive substrate.

43. An exposure apparatus according to claim 29, wherein a measuring instrument is disposed on the movable member so as to be arranged in the first space.

44. An exposure apparatus according to claim 29, wherein at least one of an illumination optical system and a projection optical system is arranged in the first space.

45. A device manufacturing method comprising:
exposing a substrate using an exposure apparatus according to claim 29 and
developing the exposed substrate.
